(19) United States
(12) Patent Application Publication
(10) Pub. No.: US 2020/0184094 A1
(43) Pub. Date: Jun. 11, 2020

(54) EFFICIENT USER AUTHENTICATION AND CORRELATION OF USER-RELATED RECORDS IN AN INFORMATION TECHNOLOGY SYSTEM

(71) Applicant: ServiceNow, Inc., Santa Clara, CA (US)

(72) Inventors: Victor Chung-Wai Chan, Saratoga, CA (US); Prithvi Yoganand, Dublin, CA (US)

(21) Appl. No.: 16/368,592

(22) Filed: Mar. 28, 2019

Related U.S. Application Data
(60) Provisional application No. 62/775,683, filed on Dec. 5, 2018.

(51) Int. Cl. G06F 21/62; G06F 21/31; G06Q 30/00; H04L 29/08

(52) U.S. Cl. CPC G06F 21/6227; H04L 67/306; G06Q 30/016; G06F 21/31

(57) ABSTRACT

A computing system includes persistent storage containing data structures storing a plurality of records of contacts and an interaction management application configured to perform operations. The operations include receiving, from a contact and before starting an interaction related to a technical problem, a plurality of data identifying the contact. An interaction entry that includes input fields to identify the contact and the technical problem and represents the interaction is generated. A record of the contact is retrieved from the data structures based on the plurality of data and an identity of the contact is authenticated based on the plurality of data matching the record. Based on authenticating the identity of the contact, the input fields of the interaction entry are populated with corresponding information from the retrieved record, an indication is provided on the interaction entry that the identity of the contact has been authenticated, and the interaction is started.

### CROSS-REFERENCE TO RELATED APPLICATION

This application claims priority to U.S. provisional patent application No. 62/775,683, filed Dec. 5, 2018, which is hereby incorporated by reference in its entirety.

### BACKGROUND

Providing services to employees and customers (e.g., information technology service management (ITSM) and customer service management (CSM)) may involve diagnosing, mitigating, resolving, and/or addressing various incidents, issues, problems, and/or requests. Some of these requests may be part of the standard operations of an enterprise, while others might not. Regardless, timely resolution of requests is important to ensuring high levels of service quality and availability of the services provided by the enterprise. Users that have such issues, problems, or requests (e.g., users experiencing technical problems) may seek assistance through various assistance channels such a phone support, chat support, email support, and walk-up support.

### SUMMARY

When a contact encounters a technical problem, the contact may seek technical assistance from an agent (e.g., an information technology technician) tasked with resolving technical problems. To obtain this assistance, the contact may initiate an interaction with the agent by way of a communication channel such as voice communication, a chat system, a web form, or another electronic messaging system. This communication channel may be integrated with or used in combination with an interaction management application that facilitates tracking and resolving the technical problems faced and reported by contacts.

The interaction management application may track the technical problems in at least two ways. First, the interaction management application may be configured to generate, modify, and store records associated with the technical problems reported by contacts. Each such record may be assigned a unique identifier and may be associated with one technical problem. The record may contain a description of the technical problem and a history of actions taken by one or more agents in an attempt to resolve the technical problem, among other attributes of the technical problem.

Second, the interaction management application may be configured to generate, modify, and store interaction entries that represent and track individual interactions between contacts and agents. That is, each time a contact interacts with an agent, an interaction entry may be generated and stored to commemorate this interaction.

For example, when a contact first interacts with an agent regarding a technical problem, the interaction management application may generate a record of the technical problem and an interaction entry for the interaction. When, at a later time, the contact again interacts with the agent, the record of the technical problem may be modified to reflect and updated and another interaction entry may be generated and stored to commemorate this additional interaction.

Additionally, the interaction management application may generate and track the relationships between the technical problem records and the interaction entries. Namely, as part of each interaction, the interaction management application may be configured to map the interaction entry to one or more identifiers associated with one or more records of technical problems addressed by the contact during the interaction. That is, each interaction entry may indicate the specific one or more technical problems that have been addressed or discussed during that interaction. This mapping may be stored as part of the interaction entry and may be analyzed for any patterns present in the technical problems reported by the contacts.

Such patterns may be aggregated together to form a profile that summarizes the determined patterns and provides the agents or network administrators with actionable conclusions. For example, by analyzing the relationships between interaction entries and records of technical problems, the interaction management application may indicate the types of technical problems that are most common or frequent, or the managed networks, computing devices, and/or software products with the most technical problems, among other possibilities. Using such information, the agents or network administrators may preemptively address expected technical problems by modifying aspects of the managed networks, computing devices, or software products, or by providing troubleshooting guides that allow contacts to resolve common technical problems without interacting with an agent.

Notably, this mapping between technical problems and interaction entries may be carried out by the interaction management application automatically. For example, based on authentication of the identity of the contact using information received therefrom, the interaction management application may be configured to automatically populate the interaction entry with the contact's info, indicate successful authentication of the contact, and map the interaction entry to any technical problems identified by the contact. Thus, the agent might not have to manually adjust the interaction entry to map this interaction entry to the technical problems identified by the contact.

In some implementations, this authentication of the contact may involve the agent. For example, the agent may ask for the contact's identifying information and, upon confirming that this information matches corresponding information stored by the interaction management application, indicate by way of a user interface of the interaction management application that the contact has been authenticated. In other implementations, however, the interaction management application may automatically carry out authentication of the contact prior to initiating the interaction with the contact. Namely, the interaction management may request that, before communicating with an agent, the contact provide data identifying the contact (e.g., name, phone number, technical problem identifier, etc.). The interaction management application may then compare this information to corresponding entries stored in databases (e.g., data structures contained in persistent storage) associated with the interaction management application.

When the data provided by the contact matches that stored in the databases, the interaction management application may automatically generate and populate the interaction entry with the contact's information, indicate on the interaction entry that the contact has been authenticated, map the interaction entry to a technical problem, and initiate an interaction with the contact (e.g., start a voice communication). In this way, the agent may be allowed to dedicate more time to resolving technical issues and less time to authenticating contact and/or mapping interaction entries to technical problems, thus improving the agent's throughput and efficiency.

Notably, in some cases, contacts may also encounter non-technical problems or have non-technical requests, and may seek assistance therewith from an agent. The interaction management application may be used to track such problems and interactions associated therewith. For example, the agent may be a representative of an enterprise, the contact may be a customer of the enterprise, and the interaction management application may form part of a customer service management (CSM) system of the enterprise. Thus, although the operations of the interaction management application are herein described in the context of technical problems, the interaction management application may also be used to track and manage other types of problems, requests, and/or interactions in various other contexts.

A first example embodiment involves a computing system that includes persistent storage containing data structures storing a plurality of records of technical problems requested to be addressed on behalf of one or more contacts and an interaction management application configured to, when executed by a processor of the computing system, perform operations. The operations include generating an interaction entry representing an interaction related to a technical problem. The interaction includes a communication with a contact of the one or more contacts. The operations also include receiving an identifier associated with a record of a particular technical problem stored in the data structures of the persistent storage. The identifier is provided by the contact during the interaction. The operations additionally include retrieving the record of the particular technical problem from the data structures of the persistent storage using the identifier. The operations further include generating a mapping between the identifier and the interaction entry to indicate the particular technical problem addressed during the interaction and storing the generated mapping in the interaction entry.

In a second example embodiment, an article of manufacture may include a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

In a fifth example embodiment, a method may include carrying out each of the operations of the first example embodiment.

In a sixth example embodiment, a computing system includes persistent storage containing data structures storing a plurality of records of contacts and an interaction management application configured to, when executed by a processor of the computing system, perform operations. Each record of the plurality of records includes information identifying a corresponding contact. The operations include receiving, from a contact, a plurality of data identifying the contact. The plurality of data is received before starting an interaction related to a technical problem. The interaction includes a communication with the contact. The operations also include generating an interaction entry representing the interaction. The interaction entry includes input fields to identify the contact and the technical problem. The operations additionally include retrieving, from the data structures of the persistent storage, a record of the contact based on at least one data element of the plurality of data and authenticating an identity of the contact based on the plurality of data matching the record of the contact. The operations further include, based on authenticating the identity of the contact, (i) populating one or more of the input fields of the interaction entry with corresponding information from the retrieved record of the contact, (ii) providing an indication on the interaction entry that the identity of the contact has been authenticated, and (iii) starting the interaction.

In a seventh example embodiment, an article of manufacture may include a non-transitory computer-readable medium, having stored thereon program instructions that, upon execution by a computing system, cause the computing system to perform operations in accordance with the sixth example embodiment.

In an eighth example embodiment, a computing system may include at least one processor, as well as memory and program instructions. The program instructions may be stored in the memory, and upon execution by the at least one processor, cause the computing system to perform operations in accordance with the sixth example embodiment.

In a ninth example embodiment, a system may include various means for carrying out each of the operations of the sixth example embodiment.

In a tenth example embodiment, a method may include carrying out each of the operations of the sixth example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A illustrates an interaction entry, in accordance with example embodiments.

FIG. 6B illustrates a search box, in accordance with example embodiments.

FIG. 6C illustrates a verification card, in accordance with example embodiments.

FIG. 6D illustrates a verified interaction entry, in accordance with example embodiments.

FIG. 7A illustrates a message flow diagram, in accordance with example embodiments.

FIG. 7B illustrates a message flow diagram, in accordance with example embodiments.

FIG. 8A illustrates a search based on a case number, in accordance with example embodiments.

FIG. 8B illustrates a record of a technical problem, in accordance with example embodiments.

FIG. 8C illustrates a mapping between an interaction ticket and a case number, in accordance with example embodiments.

FIG. 9A illustrates search parameters, in accordance with example embodiments.

FIG. 9B illustrates search parameters, in accordance with example embodiments.

FIG. 10 illustrates a message flow diagram, in accordance with example embodiments.

FIG. 11 illustrates a user interface associated with automated verification of a contact, in accordance with example embodiments.

FIG. 12 is a flow chart, in accordance with example embodiments.

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. Example Computing Devices and Cloud-Based Computing Environments

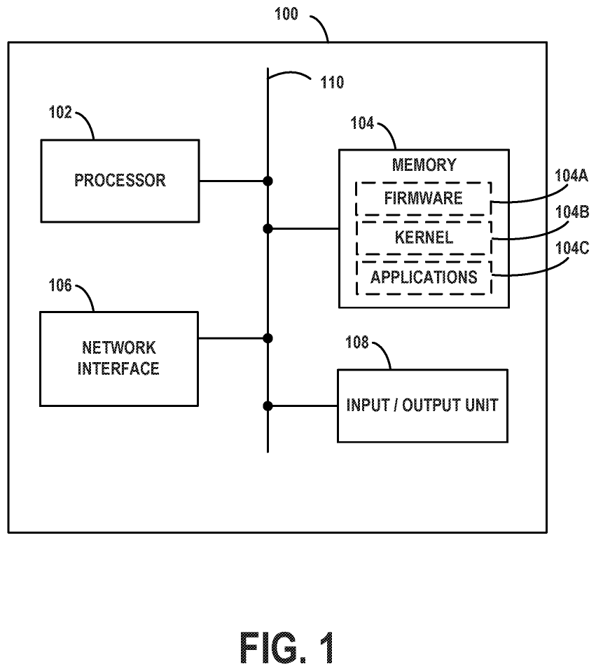

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

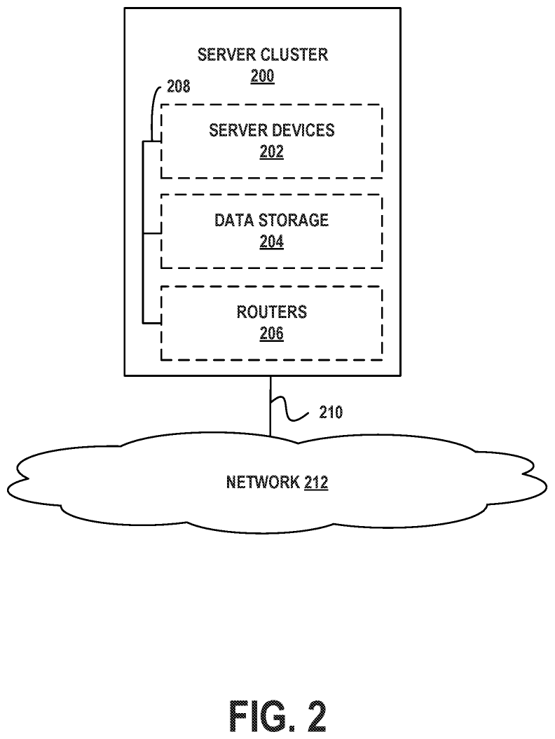

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. Example Remote Network Management Architecture

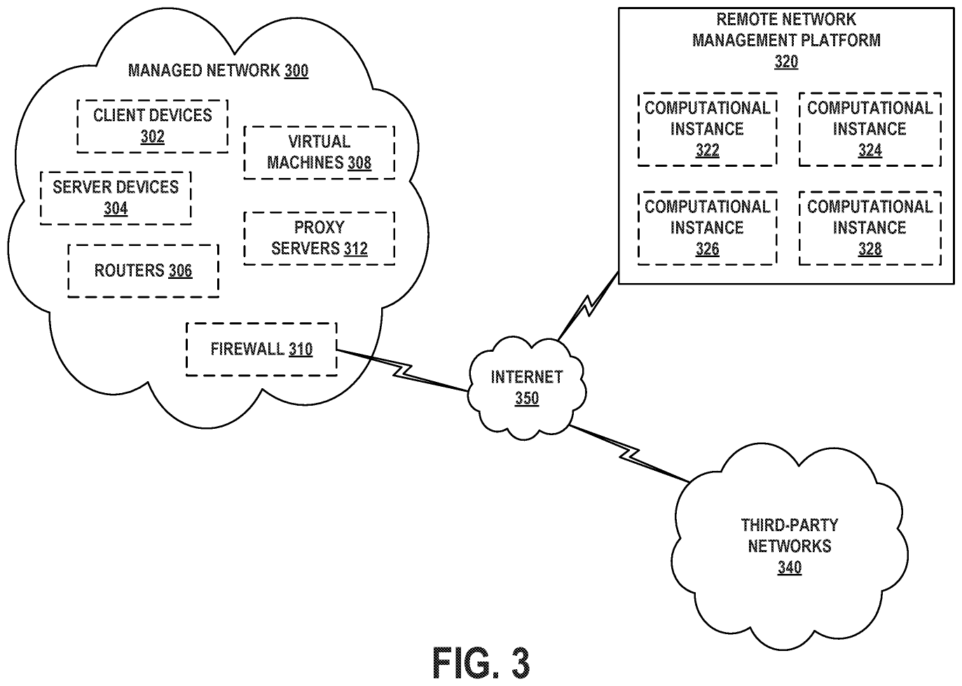

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent one or more server devices and/or one or more databases that provide a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows with one or more database tables).

For purpose of clarity, the disclosure herein refers to the physical hardware, software, and arrangement thereof as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of physical or virtual servers and database devices. Such a central instance may serve as a repository for data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

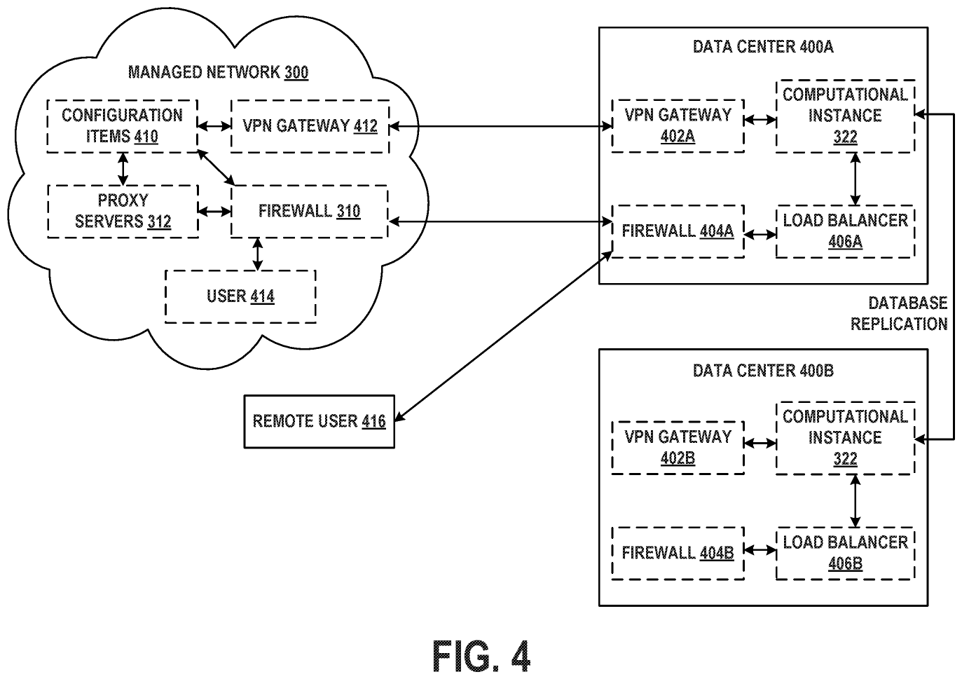

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

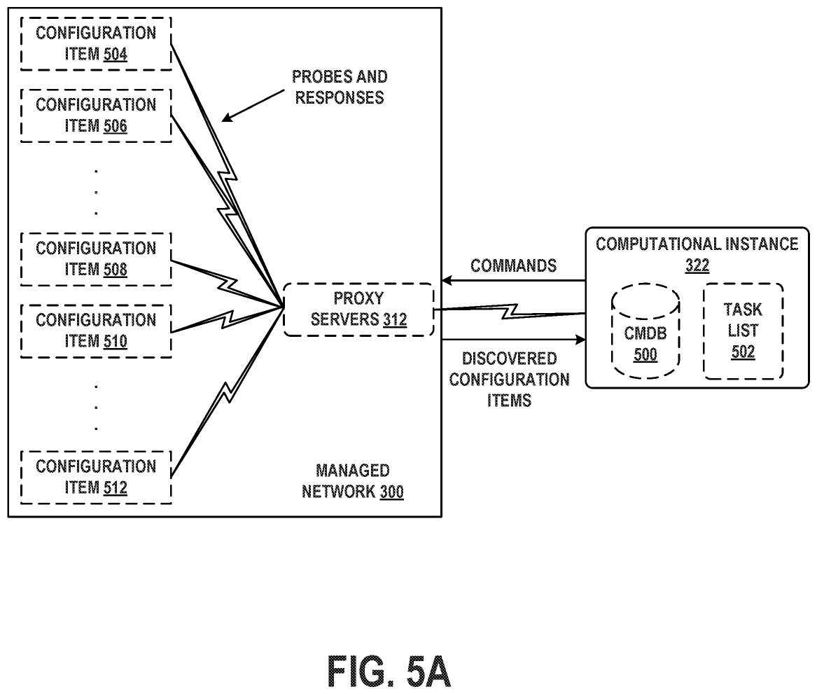

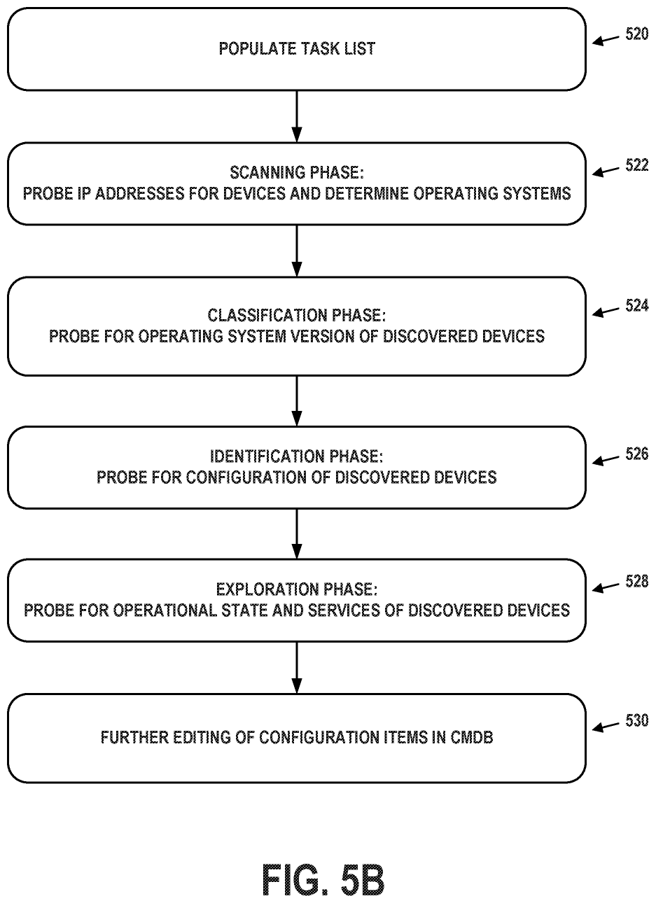

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. Example Interaction Management Application

An interaction management application is a software application configured to facilitate interactions between contacts and agents. A contact may initiate an interaction with an agent in order to obtain assistance with one or more technical issues (i.e., technical problems) or other technical questions. In one example, the contact may be a user associated with managed network 300 and the agent may be a technician associated with remote network management platform 320. Accordingly, the interaction management application may be disposed in and executable by remote network management platform 320 (e.g., computational instance 322) so that it may be used by the technician to assist the contact. The technical problems may relate, for example, to software provided by remote network management platform 320 for use by managed network 300. However, the technical problems may generally relate to any topic with respect to which the contact may benefit from assistance, including issues or problems that are not related to particular hardware or software.

In another example, the contact may be a user associated with third-party network 340 and the agent may be a technician associated with managed network 300. The technical problems may relate, for example, to hardware or software used by managed network 300 or remote network management platform 320. As one example, the technical problems may relate to software services provided by managed network 300 by way of computational instance 322. Accordingly, the interaction management application may be disposed in and executable by remote network management platform 320 (e.g., computational instance 322) or managed network 300. Again, as stated above, the technical problems may generally relate to any topic with respect to which the contact may benefit from assistance.

During an interaction between a contact and an agent, a portion of a total length of the interaction may be dedicated to the agent authenticating the contact. In general, the contact may be authenticated to determine whether the contact is actually the individual that the contact claims to be (i.e., that an actual identity of the contact matches an identity indicated or stated by the contact). Specifically, the contact may be authenticated to determine that the contact has privileges to receive assistance, access any relevant information, or make changes to any aspects of systems affected by the technical problem. By increasing the speed with which contact authentication takes place, the total length of the interaction may be reduced, thereby allowing each agent to resolve technical problems faster and thus provide assistance with a greater number of technical problems.

To that end, the agent may use the interaction management application to facilitate the process of contact authentication. Namely, the agent may use the interaction management application to search for information associated with the contact (e.g., using a name or other identifying information provided by the contact during the interaction). The agent may then ask the contact to verify some of this information by requesting that the contact provide such information to the agent. For example, the agent may search for the contact's information using the contact's first and last name, and may then ask the contact to state the contact's address to see whether this matches with the information provided by the interaction management application. Additionally, in order to keep track of the interaction, the agent may use the interaction management application to generate a ticket (i.e., an interaction entry) that keeps track of the interaction and information related thereto.

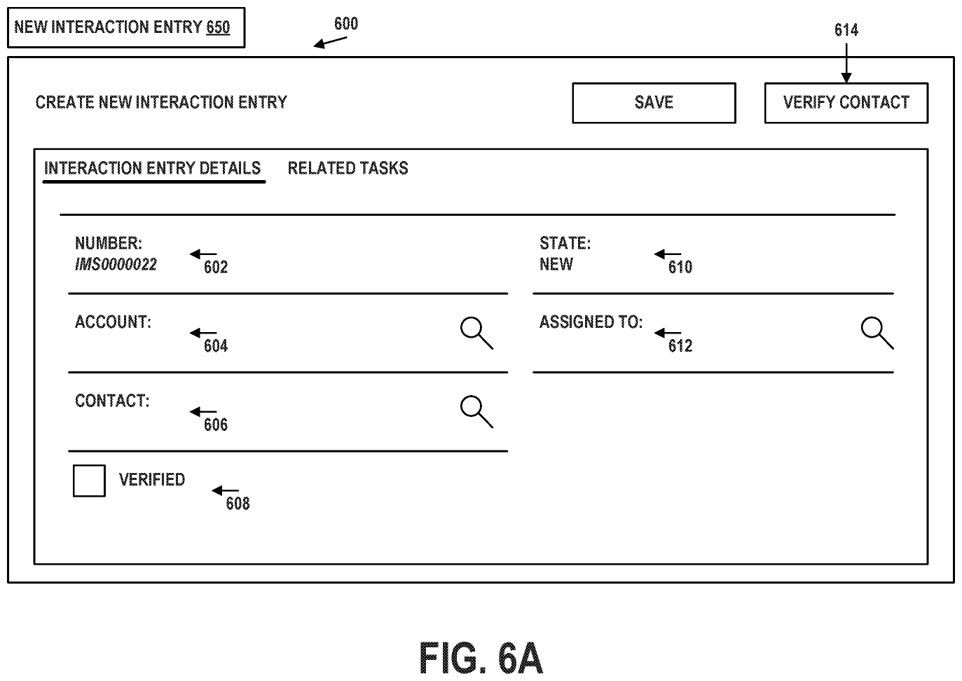

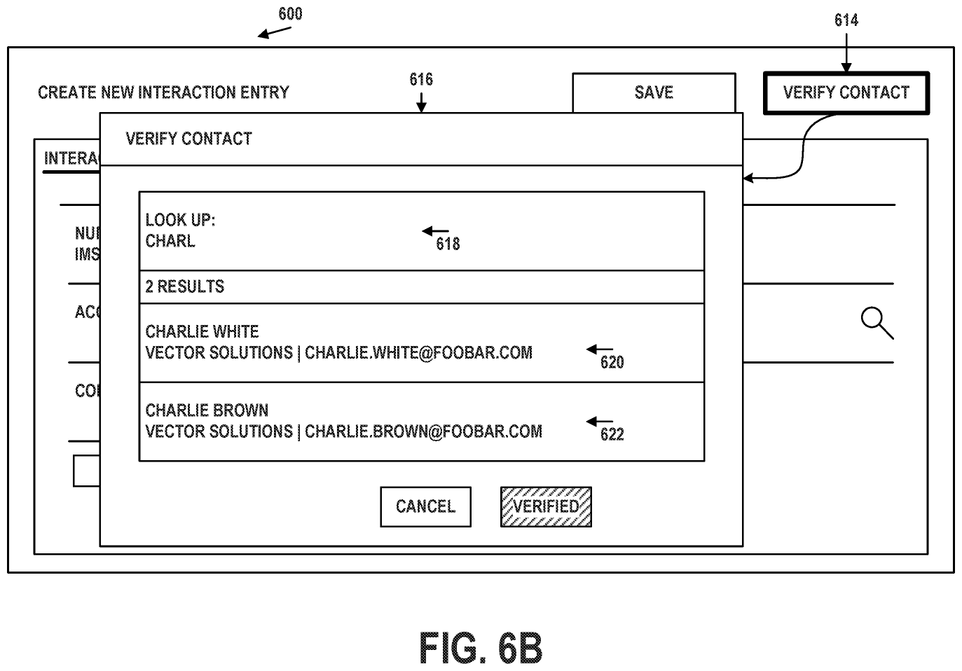

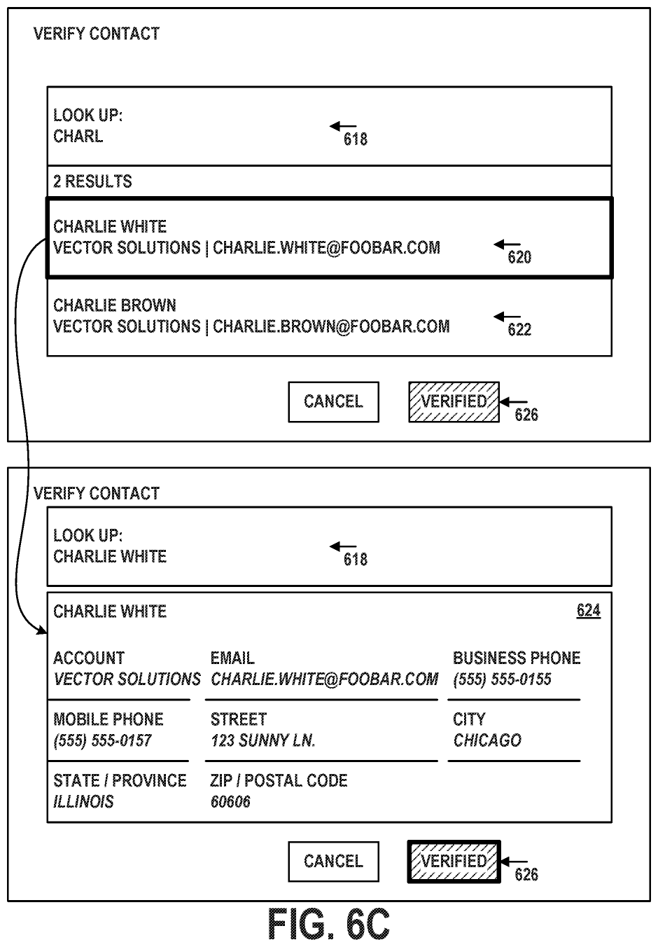

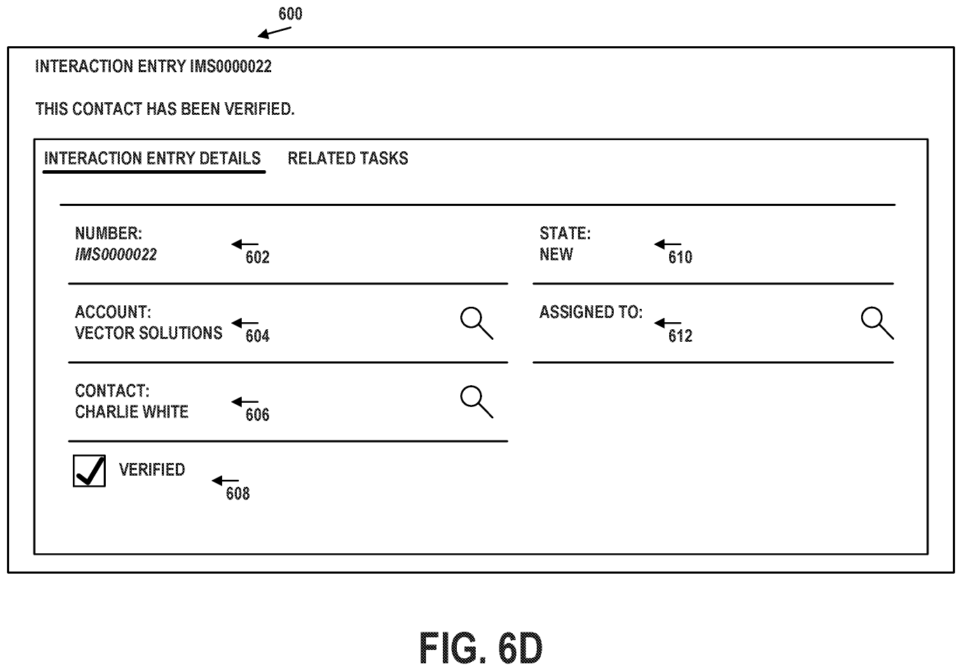

FIG. 6A illustrates an example user interface of the interaction management application. The user interface includes interaction entry/ticket 600 (“ticket” for short) generated in response to or based on initiation of an interaction between the contact and the agent. Specifically, ticket 600 includes a plurality of input fields 602-612 for information related to the interaction. Namely, ticket 600 includes interaction number field 602 that includes a unique reference number corresponding to the interaction, account field 604 for an account name or an account number associated with the contact, contact name field 606 for a first and/or last name associated with the contact, “verified” checkbox 608 for indicating whether the contact has been verified (i.e., authenticated), state field 610 for indicating a state of the ticket (e.g., new, in progress, closed), and assignment field 612 indicating a name or identifier of the agent to which ticket 600 is assigned. Alternative implementations may include additional input fields and/or fewer input fields than shown.

Upon initiation of an interaction between the contact and the agent (e.g., by phone, chat system, email, or other communication channel), the interaction management application may be used to generate ticket 600. In some implementations, ticket 600 may be generated in response to or based on interaction management application receiving a selection of the “new interaction entry” button 650 located in the top left corner of the user interface shown in FIG. 6A. For example, while communicating with the contact, the agent may interact with the user interface to select button 650. In other implementations, ticket 600 may be generated automatically, without agent input, in response to or based on interaction management application receiving from the contact a request to initiate the interaction. Ticket 600 may, for example, be generated in response to the interaction management application receiving a voice communication from the contact.

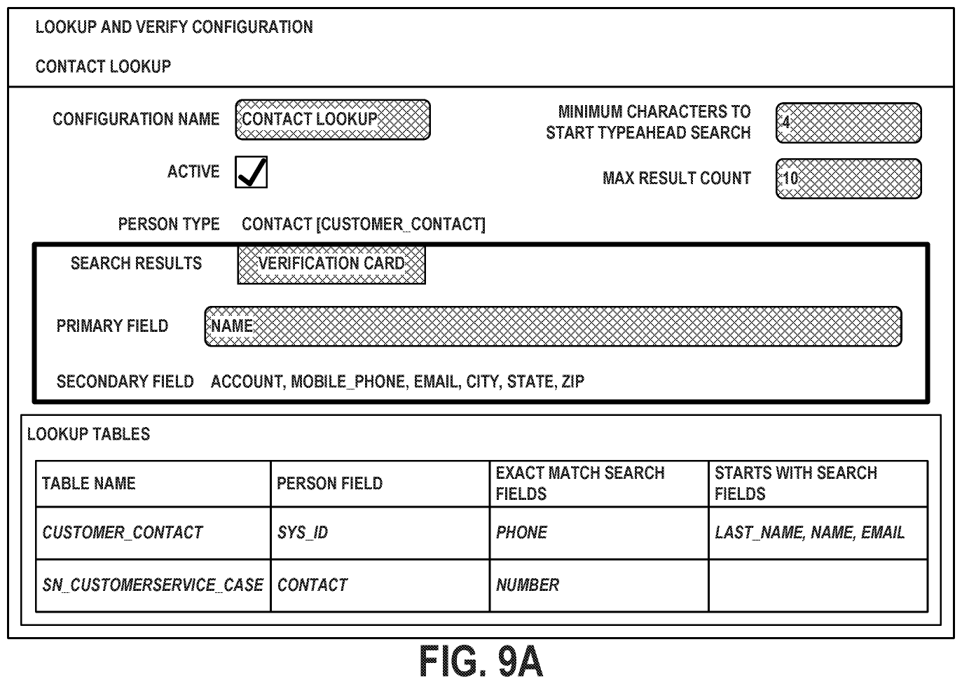

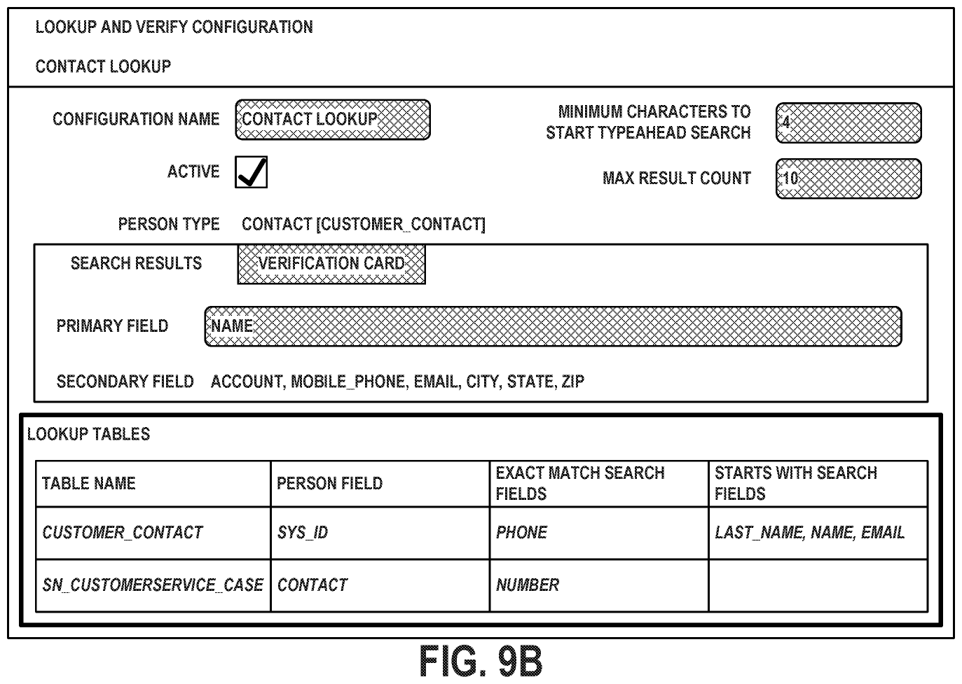

As shown in FIG. 6B, the user interface may also include, as part of interaction ticket 600, a “verify contact” button 614. Based on or in response to selection of button 614 (indicated by bolding of button 614), the interaction management application may be configured to generate a pop-up box 616, or another user interface graphic, that includes therein search box 618. Search box 618 may allow the agent to search a plurality of different fields across one or more databases associated with the interaction management application. For example, search box 618 may be used to look for information associated with a contact based on name, phone number, email, address, professional affiliation (e.g., entity or network with which the contact is associated), or case number (e.g., case number of one or more existing or prior technical problems). The specific properties of the search carried out by the interaction management application may be configurable, as will be discussed with respect to FIGS. 9A-9B.

Button 614 and search box 618 may thus be used to facilitate authentication of a contact. Notably, search box 618 allows the agent to avoid having to use different search boxes to search for different types of information. That is, the agent is not limited to using contact field 606 to search based on the contact's name or account field 604 to search based on the account associated with the contact, for example. Instead, the agent may use search box 618 to search across one or more of fields 602-612 (as well as other fields not shown in interaction entry 600) using a single search box. Thus, the agent might not have to use multiple search boxes, or manually search through different systems or databases, to locate information identifying a contact.

Additionally, the interaction management application provides look-ahead search results, as shown in FIG. 6B, based on information entered into search box 618. Thus, in response to receiving the input “charl” in search box 618, the interaction management application provides look-ahead search results 620 (i.e., Charlie White) and 622 (i.e., Charlie Brown).

As shown in FIG. 6C, based on or in response to selection of look-ahead result 620 (as indicated by bolding of result 620), the interaction management application may be configured to retrieve (e.g., from a database) a record of the contact identified in result 620. The interaction management application may display this record in the form of verification card 624. In general, a record may comprise one or more database entries related to a particular topic, matter, or subject (e.g., a technical problem or a contact).

Thus the record of the contact identified by selected result 620 may include, for example, an account name or number, email, business phone number, mobile phone number, and address information (e.g., street, city, state/province, and zip/postal code), each of which are shown on verification card 624. The agent may use the information provided in verification card 624 to verify the identity of (i.e., authenticate) the contact. That is, the agent may ask the contact to state one or more items of information contained in verification card 624 and determine whether the contact's responses match this information. Notably, the contents of verification card 624 may be configurable to suit the needs of different agents or enterprises. Thus, in some implementation, the record of the contact may include more information than is shown on verification card 624.

Based on or in response to successfully authenticating or verifying the identity of the contact, the agent may select button 626 to indicate successful authentication of the contact, as indicated by bolding of button 626 in the bottom portion of FIG. 6C. Thus, the interaction management application may be configured to receive a selection of button 626. Based on or in response to receiving the selection of button 626, the interaction management application may be configured to populate at least a portion of interaction ticket 600 with one or more items of information contained in the record of the contact and/or verification card 624.

This is shown in FIG. 6D. Namely, fields 604 and 606 may be automatically populated with the contact account and the contact name, respectively. Thus, the agent might not have to copy and paste this information from verification card 624, or from other search results, to fill out interaction ticket 600, thereby saving time and decreasing the average length of an interaction.

The interaction management application may also be configured to populate other portions of interaction ticket 600 with additional information based on or in response to selection of button 626. For example, checkbox 608 may be checked, indicating that the agent has verified the contact. Additionally, field 610, indicating a status of the interaction, may be set to “new,” indicating that ticket 600 has been recently generated. Thus, the agent might not have to manually modify interaction ticket 600 to indicate how the interaction with the contact is progressing. Instead, interaction ticket 600 may be automatically modified and updated based on or in response to interactions with other aspects of the interaction management application (e.g., selections of various buttons, updates to contact information, etc.).

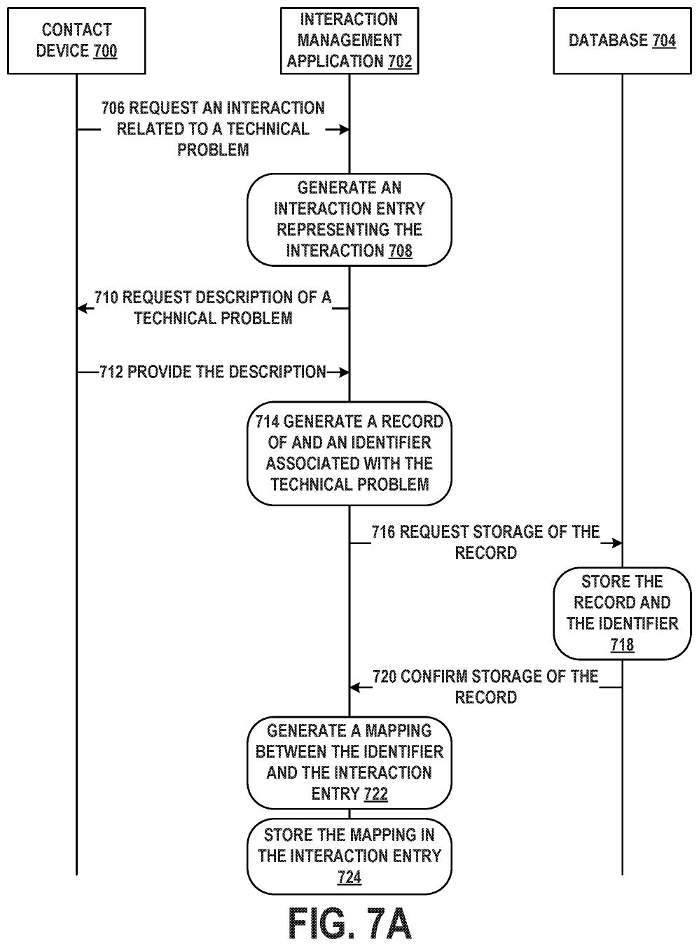

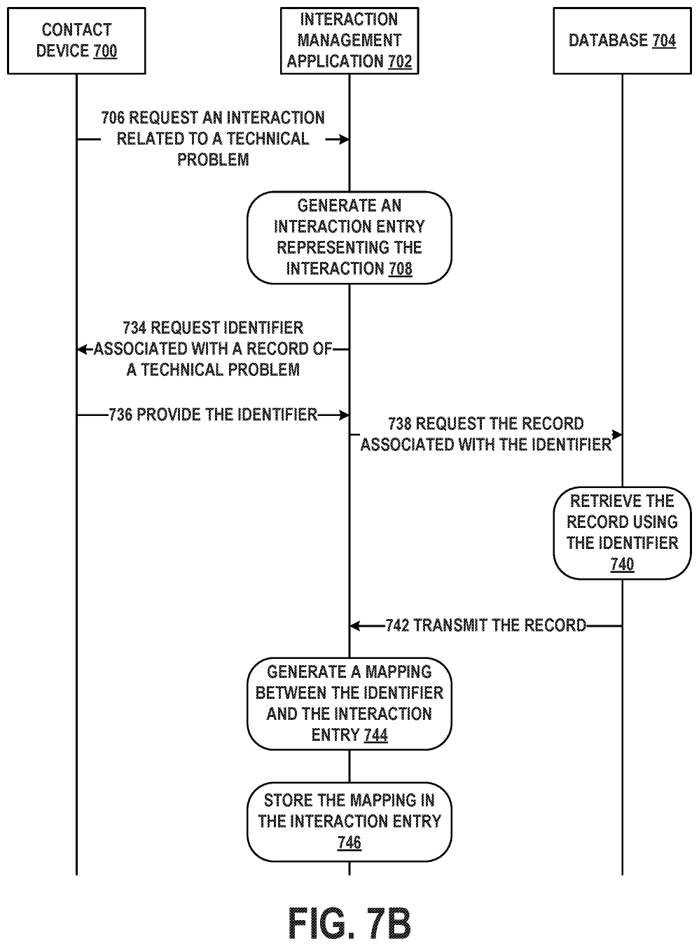

In one example, interaction ticket 600 may be modified or updated by the interaction management application to associate interaction ticket 600 with an identifier (e.g., a case number) of a record of a technical problem. By associating interaction ticket 600 with the identifier of the record of the technical problem, interaction ticket 600 may indicate the technical problems addressed during the corresponding interaction. FIGS. 7A and 7B illustrate example operations for generating a mapping between an interaction entry and a record of a technical problem. Specifically, FIG. 7A illustrates generation of a mapping between an interaction entry and a newly-created (e.g., as part of the interaction) record of a technical problem, and FIG. 7B illustrates generation of a mapping between an interaction entry and an existing (e.g., created during a prior interaction) record of a technical problem.

FIGS. 7A and 7B illustrate contact device 700, interaction management application 702, and database 704. Contact device 700 represents a computing device (e.g., personal computer, smartphone, tablet computer, etc.) used by a contact to communicate with an agent. Interaction management application 702 may, for example, be disposed in managed network 300 or remote network 320, or may be distributed therebetween. Database 704 may store a plurality of records of technical problems requested to be addressed by one or more agents on behalf of one or more contacts. Thus, database 704 may alternatively be referred to as a technical problem database. Much like interaction management application 702, database 704 may be disposed in managed network 300 or remote network management platform 320, or may be distributed therebetween.

Turning to FIG. 7A, contact device 700 may initiate an interaction by transmitting to interaction management application 702 a request for an interaction related to a technical problem, as indicated by arrow 706. In one implementation, this request may be transmitted to interaction management application 702 directly. For example, the contact may use contact device 700 to access a technical assistance web portal. By interacting with this web portal, the contact may, for example, establish a chat session between contact device 700 and interaction management application 702, with the agent being able to use interaction management application 702 to participate in the chat session. In other implementations, the request at arrow 706 may be transmitted to interaction management application 702 indirectly. For example, contact device 700 may be used to establish a voice communication with the agent, who may then interact with interaction management application 702 to convey the contact's request.

Based on or in response to requesting the interaction at arrow 706, interaction management application 702 may be configured to generate an interaction entry representing the interaction, as indicated by block 708. In one example, interaction management application 702 may do this automatically (e.g., in response to directly receiving the request at arrow 706). Alternatively, interaction management application 702 may generate the interaction entry in response to receiving selection of one or more buttons by the agent (e.g., as shown and described with respect to FIG. 6A). At this or a later time, interaction management application 702 may also be used to carry out authentication of the contact and/or contact device 700, as shown and discussed with respect to FIGS. 6A-6D.

Based on or in response to generating the interaction entry at block 708 (and/or successful authentication of the contact), interaction management application 702 may be configured to request description of a particular technical problem with which the contact is seeking assistance, as indicated by arrow 710. This request may take the form of an automatic prompt (e.g., via a chat system) or a request issued by the agent to the contact (e.g., orally as part of a voice communication).

Based on or in response to reception of the request at arrow 710, contact device 700 may be configured to allow the contact to provide a description of the technical problem, as indicated by arrow 712. The format of this description may vary depending on the communication channel used by the contact to communicate with the agent. In one example, the contact may orally describe the technical problem to the agent. In another example, the contact may fill out a web form that details aspects of the technical problem and transmit this filled-out form to interaction management application 702.

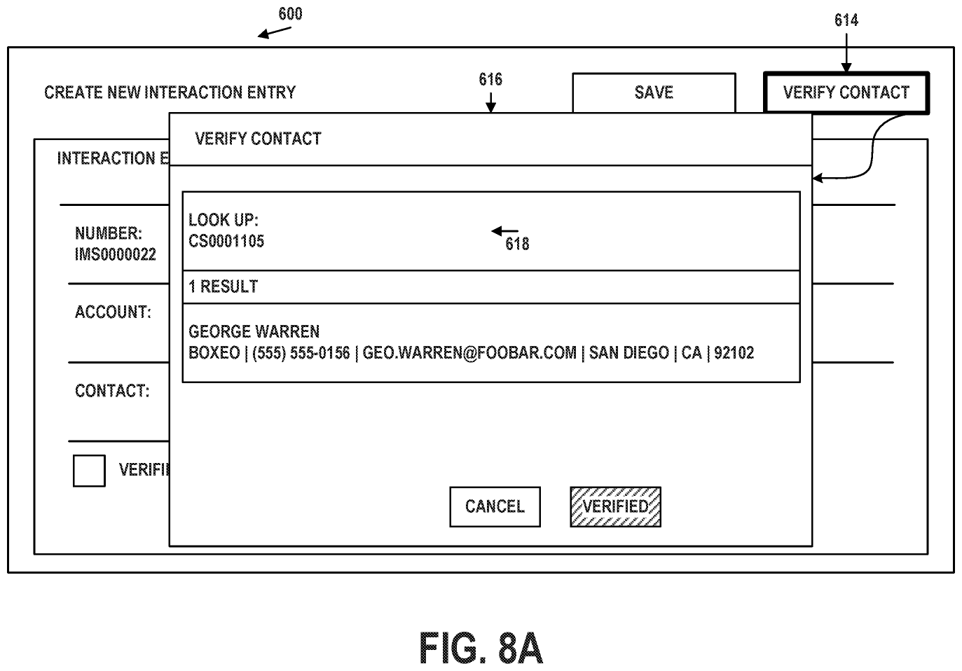

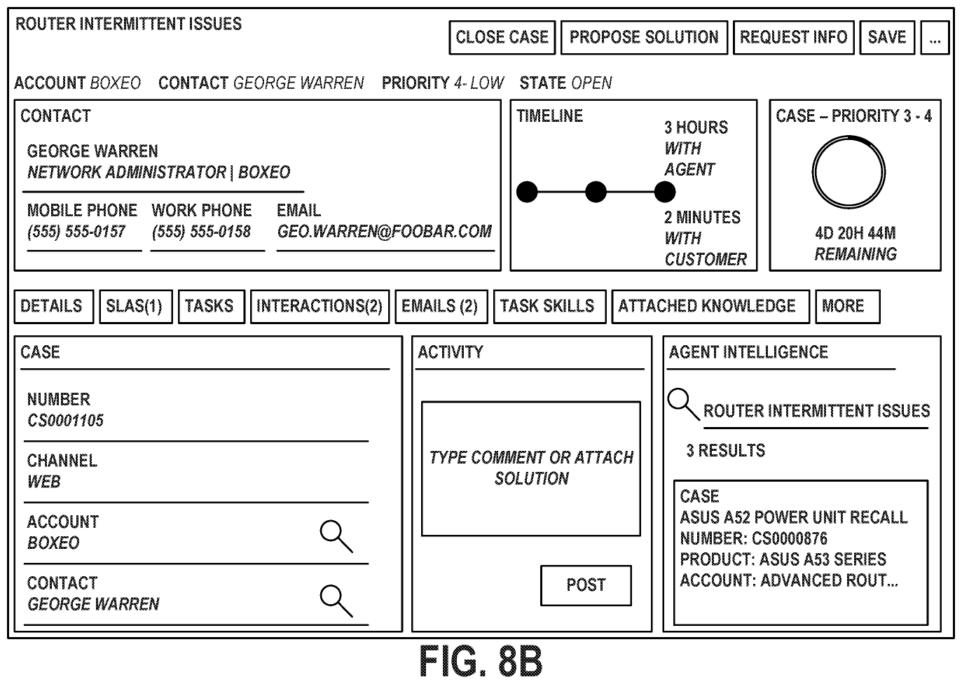

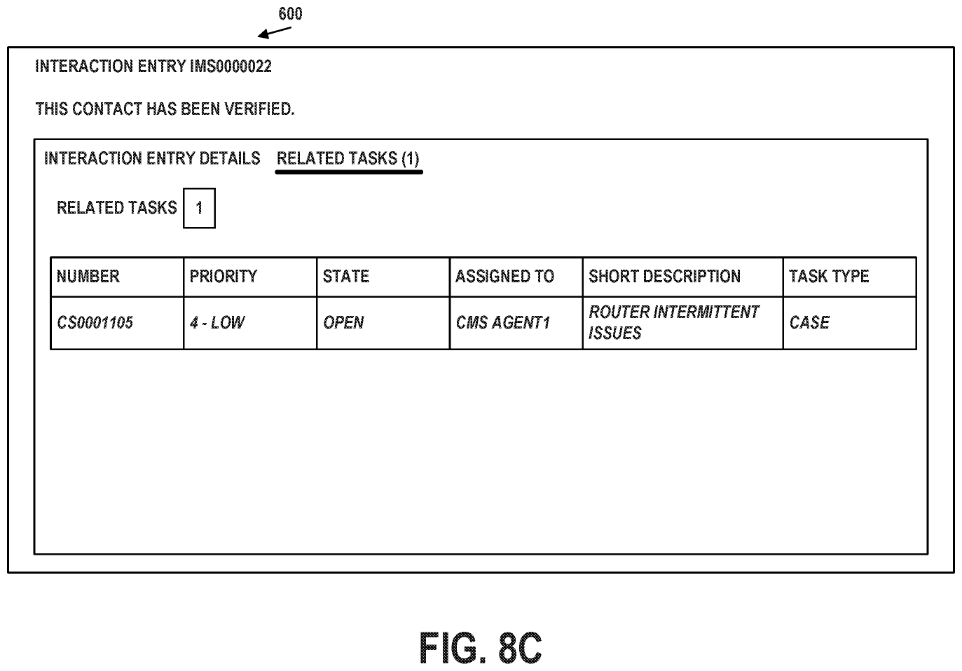

Based on or in response to reception of the description at arrow 712, interaction management application 702 may be configured to generate a record of the technical problem and an identifier associated with this record, as indicated by block 714. The record may include one or more fields that store various items of information related to the technical problem. For example, the record may include or identify one or more of a description of the technical problem, software and/or hardware involved with the technical problem, time the technical problem was reported, time the technical problem was first encountered, contact reporting the technical problem, contacts affected by the technical problem, and a priority level associated with the technical problem, among other possibilities (some of which are shown in FIG. 8B).

The identifier associated with this record may be a unique alphanumeric string that facilitates storage and retrieval of the record in and from database 704. Depending on the format of the description provided at arrow 712, the record may be completed automatically by interaction management application 702, manually by the agent, or through a combination of automated and manual updates.

Based on or in response to generation of the record and the identifier thereof at block 714, interaction management application 702 may be configured to request storage of the record in database 704, as indicated by arrow 716. Based on or in response to reception of the request at arrow 716, database 704 may be configured to store the record in association with the identifier, as indicated by block 718. Based on or in response to storage of the record at block 718, database 704 may be configured to transmit confirmation of successful storage of the record, as indicated by arrow 720. Among other benefits, storage of the record allows a technical problem to be addressed by multiple agents across multiple different interactions with one or more contacts. For example, a technical problem may initially be reported to a first agent, but may be resolved by a second agent specializing in the specific type of problem reported by the contact.

Based on or in response to reception of the confirmation at arrow 720, interaction management application 702 may be configured to generate a mapping between the identifier associated with the record of the technical problem and the interaction entry, as indicated by block 722. Based on or in response to generation of this mapping, interaction management application 702 may be configured to store the mapping in the interaction entry, as indicated by block 724. The mapping may be generated to allow interaction management application 702 to track the different technical problems that a given agent works on as part of an interaction. The mapping thus also indicates, for a given technical problem, the different contact-agent interactions involved in resolving the technical problem.

Storage of the mapping may allow for analysis of the technical problems encountered within one or more networks to identify one or more patterns in these technical problems. Analyzing the technical problems may involve grouping or classifying the technical problems into different types of technical problems. For example, technical problems may be grouped based on various attributes thereof, including whether the problem is related to hardware or software, the technician assigned to resolve the problem, resolution time, or a priority level associated with the problem.

The analysis may involve identifying patterns across the different types of technical problems. In one example, the patterns may indicate frequencies with which the different types of technical problems occur over a particular period of time and/or within a particular network or portion thereof. Additionally or alternatively, the patterns may indicate a distribution of the technical problems over time and/or a distribution of the technical problems across different managed networks or portions thereof.

In some implementations, the patterns may be aggregated or consolidated into a profile that provides a summary of the patterns. For example, the profile may rank networks (e.g., different managed networks) according to the number, frequency, or distribution of technical problems (e.g., indicate the top three enterprises experiencing the largest number of technical problems). In another example, the profile may rank the portions (e.g., departments) of a given enterprise according to the number, frequency, or distribution of technical problems. The profile may additionally or alternatively indicate the times at which technical problems are most likely to be experienced across different enterprises or within a given enterprise. These times may be correlated with other events associated with the enterprise (e.g., a software update release, a network outage, etc.) to suggest possible causal relationships between the other events and the technical problems. The profile may also aggregate or consolidate the patterns in other ways that provide actionable conclusions about the technical problems.

The profile may be stored for later use in improving operations of the systems for which interaction management application 702 facilitates issue resolution. For example, the computing devices, software, services, settings, routine practices, or other aspects of a particular enterprise may be modified based on the profile in an attempt to reduce the number of technical issues experienced thereby. Aspects of enterprises may thus be modified based on the mappings between interaction entries and technical problem identifiers to improve the operations of these enterprises and reduce requests for technical assistance by preemptively addressing technical problems.

Notably, whereas FIG. 7A illustrates operations that take place when a contact is seeking assistance with a yet unreported technical problem, FIG. 7B illustrates operations that take place when a contact is seeking additional assistance with a technical problem that has been previously reported (and perhaps not yet resolved). To that end, the operations of arrow 706 and block 708, discussed with respect to FIG. 7A, may be repeated as part of the operations of FIG. 7B. That is, the contact may request an interaction and a corresponding interaction entry may be generated. To ascertain which situation the contact is facing, interaction management application 702 may be configured to inquire whether the interaction relates to a previously-reported technical problem or a new technical problem.

Interaction management application 702 may do this by, based on or in response to generation of the interaction entry, requesting an identifier associated with a record of a particular technical problem, as indicated by arrow 734. If the contact indicates that such an identifier is unavailable (i.e., the technical problem has not previously been reported), interaction management application 702 may instead request a description of a technical problem, as indicated by arrow 710 in FIG. 7A, and proceed with the remaining operations of FIG. 7A. Alternatively, interaction management application 702 may simultaneously provide both request 710 and 734, but receive a response to only one of these inquiries. Notably, the requested identifier of the technical problem may be similar to that generated at block 714 in FIG. 7A.

When the interaction relates to a previously-reported technical problem, contact device 700 may be used to provide, to interaction management application 702, the identifier associated with the record of the technical problem, as indicated by arrow 736. The identifier may be provided by way of contact device 700 based on or in response to the request at arrow 734. Notably, the contact associated with contact device 700 may be authenticated after providing the identifier at arrow 736. However, in other implementations, the contact may also be authenticated at an earlier or later time.

Based on or in response to reception of the identifier at arrow 736 (and/or authentication of the contact), interaction management application 702 may be configured to request, from database 704, the record of the technical problem, as indicated by arrow 738. Based on or in response to reception of the request at arrow 738, database 704 may be configured to retrieve the record using the identifier, as indicated by block 740. Based on or in response to retrieving the record at block 740, database 704 may be configured to transmit the record to interaction management application 702, as indicated by arrow 742.

Based on or in response to reception of the record, interaction management application 702 may be configured to generate a mapping between the identifier and the interaction entry, as indicated by block 744. The operations of block 744 may be similar to those of block 722. Reception of the record may also cause interaction management application 702 to display visual representations of the content of this record, as will be shown and discussed with respect to FIG. 8B. Based on or in response to generating the mapping at block 744, interaction management application 702 may be configured to store the mapping in the interaction entry, as indicated by block 746. The operations of block 746 may be similar to those of block 724, and may provide similar benefits.

FIGS. 8A, 8B, and 8C illustrate aspects of a user interface that may be provided by interaction management application 702 when carrying out the operations of FIG. 7B. For example, in response to request at arrow 706, the agent may select button 614, causing pop-up box 616 to be displayed. Interaction management application 702 may then allow search box 618 to be used to search for a case number (i.e., the identifier received at arrow 736) associated with a record of a technical problem, as shown in FIG. 8A. This technical problem may have been previously reported by way of interaction management application 702 (e.g., via the operations of FIG. 7A) and a corresponding unique identifier may be associated therewith.

The record of the technical problem may indicate a corresponding contact that, for example, initially reported the technical problem or is responsible for seeing to the resolution of the technical problem. Thus, as illustrated in FIG. 8A, reception of the identifier may cause the interaction management application to provide a suggested look-ahead result (e.g., George Warren) associated with the provided identifier. Based on or in response to selecting the suggested search result, interaction management application 702 may be used to perform the operations shown and described with respect to FIGS. 6C and 6D in order to authenticate the contact seeking assistance.

Based on or in response to authenticating the contact, and after retrieving the corresponding record of the technical problem from database 704, interaction management application 702 may display a visual representation of this record, as shown in FIG. 8B. The record may include various items of information associated with this technical problem including, for example, a description of the technical problem, an identification of any hardware or software with which the technical problem is associated, agent activity carried out in association with the technical problem, communications (e.g., email) exchanged between agents and contacts while addressing the technical problem, the contact (and identifying info thereof) associated with the technical problem, a priority level of the technical problem, and a problem resolution timeline, among others. The record may include a history of the technical issue and thus be used by the agent to determine what has been done so far with respect to the technical problem and what still needs to be done in order to resolve the problem. The record may also include any resources relevant in resolving the problem including, for example, other similar technical problems that have already been resolved or troubleshooting guides.

As shown in FIG. 8C, the identifier (e.g., the case number) associated with the record of the technical problem may be mapped to or otherwise associated with interaction entry 600 to indicate the specific technical issue that was addressed or discussed during the interaction represented by interaction entry 600. Namely, FIG. 8C shows that identifier CS0001105 is mapped to interaction entry 600 as a related task. That is, the mapping of interaction entry 600 and technical problems is viewable by selecting the “RELATED TASKS” tab. Notably, one identifier may be associated with multiple interaction entries since each technical problem may necessitate multiple interactions with one or more agents in order to be resolved. Similarly, when multiple technical problems are addressed during a single interaction, multiple identifiers may be associated with one interaction entry.

The mapping between identifier CS0001105 and interaction entry 600 may be stored by interaction management application 702 as part of interaction entry 600. Notably, the stored mapping may indicate additional attributes of the technical problem (e.g., priority, state, agent to which the problem is assigned, short description, task type, etc.), as shown in FIG. 8C. Interaction entry 600 may be populated with the information shown in FIG. 8C automatically based on or in response to (i) retrieval of the record of the technical problem and/or (ii) authentication of the contact. Thus, the agent might not need to dedicate any time to manually populating such portions of the interaction entry, thus allowing for a shorter interaction with the contact.

### VI. Example Search Scope Configuration

FIGS. 9A and 9B illustrate example configurations that may be modified to customize the results generated by the search carried out by interaction management application 702 in response to input into search box 618 shown in FIGS. 6B and 8A. Namely, FIGS. 9A and 9B illustrate a user interface that may be used to modify these configurations. Specifically, FIG. 9A indicates with a bolded outline a portion of the user interface that may be used to select (i) the primary field of the search results and (ii) the secondary fields of the search results. In one example, the primary field may be a name of the contact and the secondary fields may include the account name, mobile phone number, email, city, state, and zip code associated with the contact, thus allowing for two contacts with the same primary field to be disambiguated.

Notably, the example search result illustrated in FIG. 8A adheres to the specification of primary and secondary fields shown in FIG. 9A. That is, the name “GEORGE WARREN” is shown in the top line of the suggested result, while the account name “BOXEO,” mobile phone number “(555) 555-0156,” email “GEO.WARREN@FOOBAR.COM,” city “SAN DIEGO,” state “CA,” and zip code “92102” are shown in the line below. On the other hand, FIG. 6B illustrates an implementation where the primary field includes the name and the secondary fields include the account name and email, but not the mobile phone number, city, state, or zip associated with the contact. The user interface of FIG. 9A may also be used to generate other combinations of primary and secondary fields.

The user interface of FIG. 9A may additionally be used to select the information that is displayed as part of verification card 624. Namely, by selecting the “VERIFICATION CARD” tab, the contents of the verification card may be specified by, for example, checking boxes corresponding to the information to be displayed as part of the verification card and unchecking boxes corresponding to information to be omitted from verification card 624.

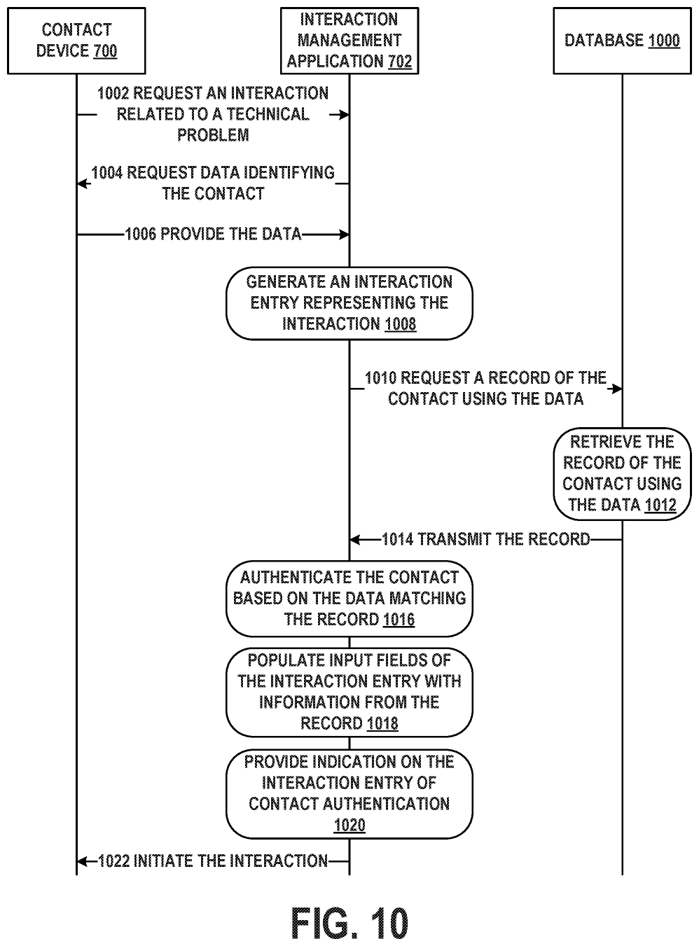

FIG. 9B indicates, with a bolded outline, another portion of the user interface that may be used to select the database tables and the fields therein that define the scope of the search carried out by interaction management application 702 based on input to search box 618. For example, FIG. 9B illustrates that the search references a first table called “CUSTOMER_CONTACT” (e.g., stored in database 1000, as will be discussed with respect to FIG. 10) and a second table called “SN_CUSTOMERSERVICE_CASE” (e.g., stored in database 704). The first table includes information items associated with a plurality of different contacts, while the second table includes information items associated with a plurality of different case numbers (i.e., identifiers) previously defined by interaction management application 702.

Further, for each table, interaction management application 702 defines the parameters for the search associated with the different data elements (i.e., items of information) therein. For example, the phone number in the first table and the case number in the second table each necessitate an exact match before a look-ahead result is provided. On the other hand, the last name, first name, and email in the first table necessitate at least a partial match (e.g., a “starts with” match) before a look-ahead search result is provided. Notably, these search parameters are modifiable, allowing agents to scope the look-ahead search results based on various preferences and factors.

The user interface shown in FIGS. 9A and 9B may further be used to specify additional properties related to the search carried out by interaction management application 702 in response to input into search box 618. For example, a minimum number of input characters for search box 618 that causes interaction management application 702 to initiate a search may be specified (e.g., 4), as well as the maximum number of look-ahead results presented based on the search (e.g., 10).

### VII. Example Automated Verification

In some implementations of the interaction management application, a contact may be allowed to provide identifying information prior to interacting with an agent, rather than providing this information to the agent during the interaction. For example, when the contact calls in to reach an agent, an interactive voice response (IVR) system may ask the contact to provide one or more items of information such as, for example, the contact's name, account number, email, phone number, address, or case number (i.e., technical problem identifier), among other possibilities. The interaction management application may be configured to use this information to authenticate the identity of the contact prior to initiating an interaction with the agent. Thus, upon initiating the interaction, the contact may omit the authentication steps and may proceed instead to addressing the technical problem with which the contact is seeking assistance.

FIG. 10 illustrates a message diagram with example operations involved in automatically authenticating a contact prior to initiating the interaction with the agent. The interaction between the contact and the agent may be facilitated by contact device 700 and interaction management application 702, which have been previously described with respect to at least FIGS. 7A and 7B. FIG. 10 additionally illustrates database 1000 which stores a plurality of records of contacts, with each record including information identifying the corresponding contact. Thus, database 1000 may alternatively be referred to as a contact database. Depending on the implementation, database 1000 may be disposed in remote network management platform 320 or in managed network 300, or may be distributed therebetween.

Contact device may transmit, to interaction management application 702, a request for an interaction related to a technical problem, as indicated by arrow 1002. The operations of arrow 1002 may be similar to those of arrow 706 in FIGS. 7A and 7B. Based on or in response to the request at arrow 1002, interaction management application 702 may be configured to request, from contact device 700, data identifying the contact (examples of which have been provided above). The request at arrow 1004 may be transmitted by interaction management application 702 automatically. For example, interaction management application 702 may be configured to transmit the request at arrow 1004 by way of an IVR communication, a chat system, or another electronic messaging system, among other possibilities. The format of the request at arrow 1004 may depend on the communication channel by way of which the request at arrow 1002 is transmitted.

Based on or in response to reception of the request at arrow 1004, contact device 700 may be used to provide the requested data, as indicated by arrow 1006. In one implementation, the contact may use contact device 700 to manually enter the information requested by interaction management application 702. In other implementations, some or all of the requested information may be provided by contact device 700 automatically. Namely, the contact's identifying information may be stored by contact device 700 in association with the contact's log-in information. Thus, once the contact has logged-in to contact device 700 or a web service associated therewith, the identifying information may be retrieved and provided automatically (e.g., with the contact's permission).

Based on or in response to reception of the data at arrow 1006, interaction management application 702 may be configured to generate an interaction entry representing the interaction with the contact, as indicated by block 1008. The operations of block 1008 may be similar to those of block 708 in FIGS. 7A and 7B. The interaction entry may include input fields that interaction management application 702 may be configured to automatically populate before the contact is provided an opportunity to interact with an agent.

To that end, interaction management application 702 may be configured to request a record of the contact that initiated the interaction, as indicated by arrow 1010. The record may be requested using at least one data element of the data provided at arrow 1006 (e.g., the contact's first and last name). Based on or in response to reception of the request at arrow 1010, database 1000 may be configured to retrieve the record of the contact using the at least one data element, as indicated by block 1012. In the event of an ambiguity between two contacts, either database 1000 or interaction management application 702 may be configured to select one of these two contacts based on additional elements of the data received at arrow 1006 (or additional identifying data requested thereafter). Based on or in response to retrieval of the record at block 1012, database 1000 may be configured to transmit the record to interaction management application 702, as indicated by arrow 1014.

Based on or in response to reception of the record at arrow 1014, interaction management application 702 may be configured to authenticate the contact based on the data received at arrow 1006 (and/or any additional identifying information provided by contact device 700) matching the retrieved record of the contact, as indicated by block 1016. For example, when a record of the contact is retrieved from database 1000 based on a first and last name provided by the contact, the contact may be authenticated based on the contact's phone number (provided by the contact) matching the phone number contained in the record.

In some implementations, authentication of the contact may also involve transmission of a temporary identifier to a computing device or messaging account associated with the contact (e.g., stored in the record). This transmission may be by email, text message, or phone call, for example. The contact may then be requested to repeat this temporary identifier to interaction management application 702 (and/or to the agent) in order to complete the authentication. Notably, such authentication may be referred to as two-factor authentication.

Based on or in response to authentication of the contact at block 1016, interaction management application 702 may be configured to populate input fields of the interaction entry with information from the retrieved record, as indicated by block 1018. For example, the interaction entry may be populated with the contact's first and last name and the name of the account with which the contact is associated, among other possibilities. Population of the interaction ticket at block 1018 may be similar to that described with respect to FIGS. 6C and 6D, but with the authentication process being carried out automatically without input by the agent.

Additionally, interaction management application 702 may modify the interaction entry to provide thereon an indication that the contact has been authenticated, as indicated by block 1020. This indication may take the form of a checkbox in the interaction entry being marked with a check mark, possibly along with other visual indicia (e.g., changing the color of the visual representation of the interaction entry to green).

Based on one or more of the operation of block 1016, 1018, or 1020, interaction management application 702 may be configured to initiate the interaction with the contact, as indicated by arrow 1022. Interaction management application 702 may thus automatically (without involvement by the agent) generate the interaction entry, authenticate the contact, and populate the interaction entry before initiating the interaction between the contact and agent. Accordingly, the agent may use the additional time that would otherwise be used to manually carry out these tasks to provide technical assistance with other technical problems. Thereby, the proportion of the agent's time dedicated to problem resolution may be increased and the proportion of the agent's time dedicated to contact authentication and documentation of the interaction may be decreased.

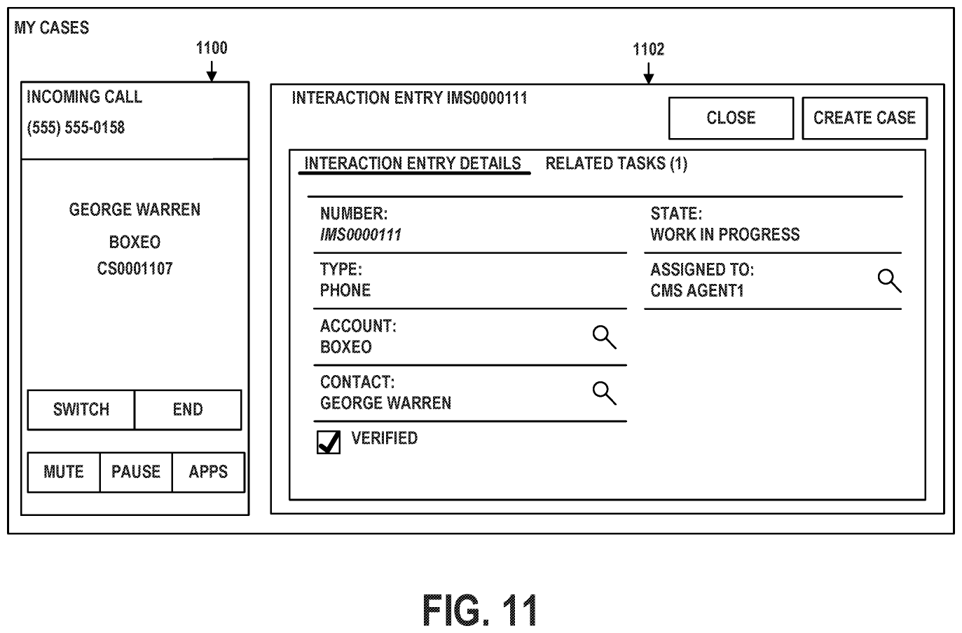

FIG. 11 illustrates an example user interface that may be provided by interaction management application 702 as part of an automated verification interaction such as that discussed with respect to FIG. 10. Namely, contact “GEORGE WARREN” may attempt to reach an agent via phone in order to receive assistance with a technical issue. Prior to being connected with the agent, the contact may be asked for and provide data identifying the contact. In the example of FIG. 11, the contact provides a case number (i.e., identifier) associated with a technical problem regarding which the contact is calling. The case number may be provided to interaction management application 702 by the contact with the assistance of contact device 700 and an IVR system provided by interaction management application 702 or another related application. Thus, the data received at arrow 1006 of FIG. 10 may include the identifier associated with the technical problem.

Using this identifier, interaction management application 702 may retrieve the record of the technical problem, which may include therein data that identifies the contact “GEORGE WARREN.” In this way, interaction management application 702 may more easily obtain the plurality of data identifying the contact, namely, by using a single input (i.e., the case number), rather than by receiving each data element of the plurality of data directly from contact 700. Nevertheless, in some cases (e.g., when no case number is available), interaction management application 702 may also obtain this information by receiving it directly from the contact by way of contact device 700. Interaction management application 702 may also retrieve additional information regarding “GEORGE WARREN” from database 1000 using data found in the record of the technical problem.

Additionally, interaction management application 702 may automatically receive from contact device 700 the phone number associated with contact device 700. This phone number may thus be another element of the data received at arrow 1006. When the phone number from which the contact is calling matches a phone number in the record associated with the identifier provided by the contact (or the phone number associated with “GEORGE WARREN” in database 1000), the interaction management application may automatically verify the contact. In other implementations, this phone number may be provided by the contact manually as part of the operations of arrow 1006.

Based on or in response to verifying the contact, interaction management application 702 may initiate the interaction by displaying phone application 1100 to the agent. Phone application 1100 may generate sounds to alert the agent to the requested interaction.

Additionally, based on or in response to verifying the contact or the agent answering the call from the contact using phone application 1100, interaction management application 702 may display interaction entry 1102 which has been populated with information associated with the contact. Namely, for example, the “CONTACT” field may be populated with the name “GEORGE WARREN” and the “ACCOUNT” field may be populated with “BOXEO.” Additionally, the “verified” checkbox may be checked, indicating to the agent that the contact has already been successfully authenticated by interaction management application 702 and that manual verification by the agent is not necessary.

Additionally, when the contact provides a case number, this case number may be automatically mapped to interaction entry 1102 and stored therein, allowing for tracking of the relationships between technical problems and interactions. This mapping may be viewed by the agent by selecting the “RELATED TASKS” tab of interaction entry 1102, much like shown in and discussed with respect to FIG. 8C.

The interaction management application may be configured to perform a similar verification process for other communication channels. For example, the contact may be automatically verified when attempting to contact an agent via an online chat system. In such a case, the contact may provide the identifying information by way of a web-based form, for example. Alternatively, when the contact is logged in to a computing device or service, the identifying information may be provided to the interaction management application automatically. That is, the identifying information may be stored in association with the login information and, when the contact is logged in, may be provided without manual input by the contact. Once the contact is authenticated, the agent may receive a visual or audible indication that an authenticated contact is ready to receive technical assistance.

### VIII. Example Operations

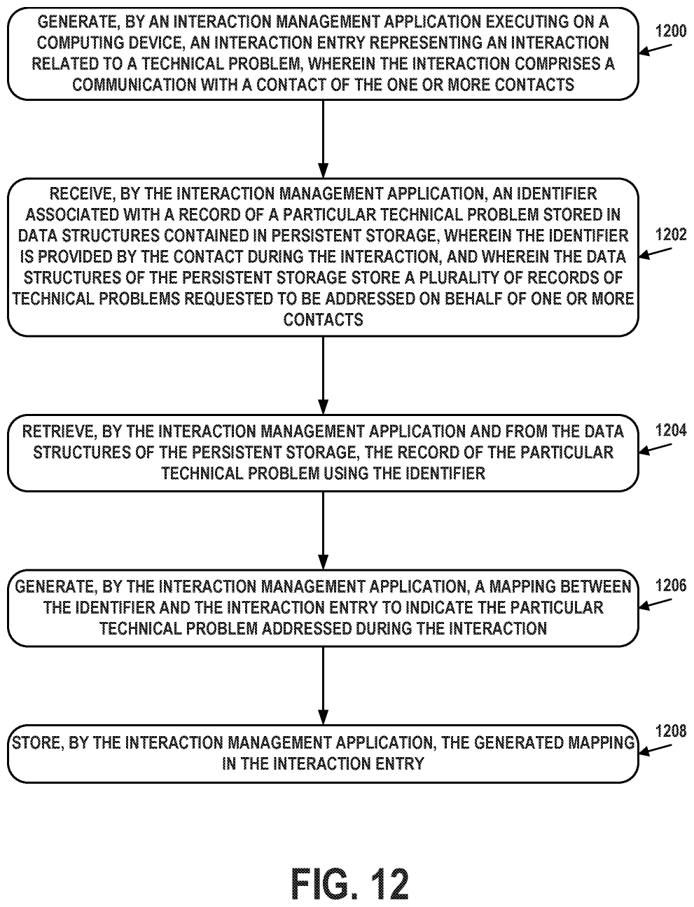

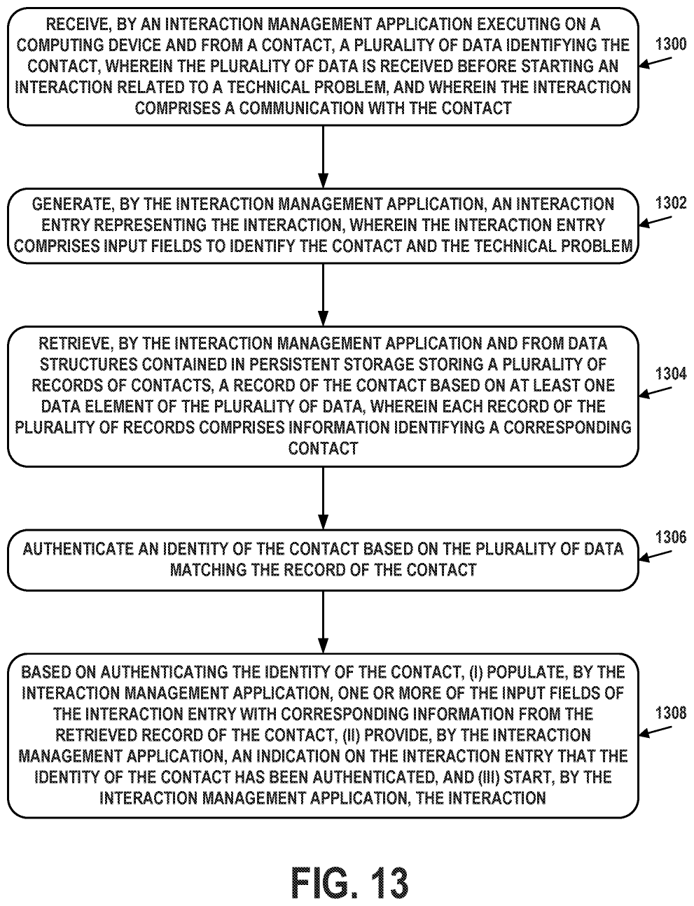

FIGS. 12 and 13 are flow charts illustrating example embodiments. The processes illustrated by FIGS. 12 and 13 may be carried out by a computing device, such as computing device 100, and/or a cluster of computing devices, such as server cluster 200. However, the processes can be carried out by other types of devices or device subsystems. For example, the processes could be carried out by a portable computer, such as a laptop or a tablet device. The processes may be carried out or facilitated by, for example, an interaction management application.

The embodiments of FIGS. 12 and 13 may be simplified by the removal of any one or more of the features shown therein. Further, these embodiments may be combined with features, aspects, and/or implementations of any of the previous figures or otherwise described herein.

Regarding FIG. 12, block 1200 may involve generating, by an interaction management application executing on a computing device, an interaction entry representing an interaction related to a technical problem. The interaction may include a communication with a contact of the one or more contacts.

Block 1202 may involve receiving, by the interaction management application, an identifier associated with a record of a particular technical problem stored in data structures contained in persistent storage. The identifier may be provided by the contact during the interaction. The data structures of the persistent storage may store a plurality of records of technical problems requested to be addressed on behalf of one or more contacts. The data structures contained in the persistent storage may form at least part of a database.

Block 1204 may involve retrieving, by the interaction management application and from the data structures of the persistent storage, the record of the particular technical problem using the identifier.

Block 1206 may involve generating, by the interaction management application, a mapping between the identifier and the interaction entry to indicate the particular technical problem addressed during the interaction.

Block 1208 may involve storing, by the interaction management application, the generated mapping in the interaction entry.

In some embodiments, based on retrieving the record of the particular technical problem from the data structures of the persistent storage, a verification card may be displayed. The verification card may include a plurality of data identifying a contact associated with the record of the particular technical problem. Confirmation that at least one data element from the plurality of data has been verified during the interaction may be received. Based on receiving the confirmation, visual representations of the record of the particular technical problem may be displayed.

In some embodiments, based on receiving the confirmation, one or more input fields of the interaction entry may be populated with corresponding information from the retrieved record of the particular technical problem.

In some embodiments, the identifier associated with the record of the particular technical problem may be received by way of a search box provided by a user interface of the interaction management application. In response to receiving an input by way of the search box, the interaction management application may be configured to search a plurality of fields of one or more data structures according to respective search parameters. The plurality of fields may correspond to a plurality of input fields contained in the interaction entry. The search parameters may include one or more of (i) an exact match between the input and a value in one or more of the plurality of fields or (ii) a partial match between the input and the value in one or more of the plurality of fields.

In some embodiments, the plurality of fields may include two or more of name, email, phone number, professional affiliation, address, or identifier associated with a record of a technical problem.

Regarding FIG. 13, block 1300 may involve receiving, by an interaction management application executing on a computing device and from a contact, a plurality of data identifying the contact. The plurality of data may be received before starting an interaction related to a technical problem. The interaction may include a communication with the contact.

Block 1302 may involve generating, by the interaction management application, an interaction entry representing the interaction. The interaction entry may include input fields to identify the contact and the technical problem.

Block 1304 may involve retrieving, by the interaction management application and from data structures contained in persistent storage storing a plurality of records of contacts, a record of the contact based on at least one data element of the plurality of data. Each record of the plurality of records may include information identifying a corresponding contact. The data structures contained in the persistent storage may form at least part of a database.

Block 1306 may involve authenticating an identity of the contact based on the plurality of data matching the record of the contact.

Block 1308 may involve, based on authenticating the identity of the contact, (i) populating, by the interaction management application, one or more of the input fields of the interaction entry with corresponding information from the retrieved record of the contact, (ii) providing, by the interaction management application, an indication on the interaction entry that the identity of the contact has been authenticated, and (iii) starting, by the interaction management application, the interaction.

In some embodiments, additional data structures contained in the persistent storage may store a plurality of records of technical problems requested to be addressed on behalf of one or more of the contacts. An identifier associated with a record of the technical problem stored in the additional data structures may be received from the contact. The record of the technical problem may be retrieved from the additional data structures using the identifier. A mapping between the identifier and the interaction entry may be generated to indicate the technical problem addressed during the interaction.

In some embodiments, the identifier associated with the record of the technical problem may be received before starting the interaction related to the technical problem.

In some embodiments, the plurality of data identifying the contact may include at least the identifier associated with the record of the technical problem. Retrieving the record of the contact based on the at least one data element may include retrieving additional data identifying the contact from the record of the technical problem in the additional data structures and retrieving the record of the contact based on the additional data.

In some embodiments, at a first time, (i) the interaction entry and (ii) the mapping between the identifier and the interaction entry may be stored for later retrieval and analysis. At a second time later than the first time, (i) stored interaction entries and (ii) stored mappings between identifiers and corresponding interaction entries may be analyzed to identify one or more patterns in the technical problems requested to be addressed on behalf of the one or more of the contacts. A profile of the technical problems may be generated based on the one or more patterns. The profile may indicate frequencies with which different types of the technical problems are requested to be addressed on behalf of the one or more of the contacts. The profile may be stored to be used in modifying a managed network in which at least a portion of the technical problems occur.

In some embodiments, receiving the plurality of data identifying the contact may include receiving the plurality of data by way of an interactive voice response system. The communication with the contact may include a voice communication.

In some embodiments, receiving the plurality of data identifying the contact may include receiving the plurality of data by way of a chat system. The communication with the contact may include a chat communication.

In some embodiments, receiving the plurality of data identifying the contact may include receiving the plurality of data from a computing device configured to store the plurality of data in association with log-in credentials of the contact. The computing device may be configured to provide the plurality of data in response to the contact requesting to start the interaction by way of the computing device after providing the log-in credentials to the computing device.

In some embodiments, receiving the plurality of data identifying the contact may include receiving the plurality of data from the contact by way of a web-based form.

In some embodiments, providing the indication on the interaction entry that the identity of the contact has been authenticated includes displaying visual indicia indicating a status of an authentication of the identity of the contact. The visual indicia may have a first appearance when the identity of the contact has been verified and a second different appearance when the identity of the contact has not been verified.

### IX. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computing system comprising:
persistent storage containing data structures storing a plurality of records of technical problems requested to be addressed on behalf of one or more contacts; and
an interaction management application configured to, when executed by a processor of the computing system, perform operations comprising:
generating an interaction entry representing an interaction related to a technical problem, wherein the interaction comprises a communication with a contact of the one or more contacts;
receiving an identifier associated with a record of a particular technical problem stored in the data structures of the persistent storage, wherein the identifier is provided by the contact during the interaction;
retrieving the record of the particular technical problem from the data structures of the persistent storage using the identifier;
generating a mapping between the identifier and the interaction entry to indicate the particular technical problem addressed during the interaction; and
storing the generated mapping in the interaction entry.

2. The computing system of claim 1, wherein the operations further comprise:
based on retrieving the record of the particular technical problem from the data structures of the persistent storage, displaying a verification card comprising a plurality of data identifying a contact associated with the record of the particular technical problem;
receiving confirmation that at least one data element from the plurality of data has been verified during the interaction; and
based on receiving the confirmation, displaying visual representations of the record of the particular technical problem.

3. The computing system of claim 2, wherein the operations further comprise:
based on receiving the confirmation, populating one or more input fields of the interaction entry with corresponding information from the record of the particular technical problem.

4. The computing system of claim 1, wherein the identifier associated with the record of the particular technical problem is received by way of a search box provided by a user interface of the interaction management application, wherein, in response to receiving an input by way of the search box, the interaction management application is configured to search a plurality of fields of one or more data structures according to respective search parameters, wherein the plurality of fields correspond to a plurality of input fields contained in the interaction entry, and wherein the search parameters comprise one or more of (i) an exact match between the input and a value in one or more of the plurality of fields or (ii) a partial match between the input and the value in one or more of the plurality of fields.

5. The computing system of claim 4, wherein the plurality of fields comprise two or more of (i) name, (ii) email, (iii) phone number, (iv) professional affiliation, (v) address, or (vi) identifier associated with a record of a technical problem.

6. A computing system comprising:
persistent storage containing data structures storing a plurality of records of contacts, wherein each record of the plurality of records comprises information identifying a corresponding contact; and
an interaction management application configured to, when executed by a processor of the computing system, perform operations comprising:
receiving, from a contact, a plurality of data identifying the contact, wherein the plurality of data is received before starting an interaction related to a technical problem, and wherein the interaction comprises a communication with the contact;
generating an interaction entry representing the interaction, wherein the interaction entry comprises input fields to identify the contact and the technical problem;
retrieving, from the data structures of the persistent storage, a record of the contact based on at least one data element of the plurality of data;
authenticating an identity of the contact based on the plurality of data matching the record of the contact; and
based on authenticating the identity of the contact, (i) populating one or more of the input fields of the interaction entry with corresponding information from the retrieved record of the contact, (ii) providing an indication on the interaction entry that the identity of the contact has been authenticated, and (iii) starting the interaction.

7. The computing system of claim 6, further comprising additional data structures contained in the persistent storage storing a plurality of records of technical problems requested to be addressed on behalf of one or more of the contacts, wherein the operations further comprise:
receiving, from the contact, an identifier associated with a record of the technical problem stored in the additional data structures;
retrieving the record of the technical problem from the additional data structures using the identifier; and
generating a mapping between the identifier and the interaction entry to indicate the technical problem addressed during the interaction.

8. The computing system of claim 7, wherein the identifier associated with the record of the technical problem is received before starting the interaction related to the technical problem.

9. The computing system of claim 7, wherein the plurality of data identifying the contact comprises at least the identifier associated with the record of the technical problem, and wherein retrieving the record of the contact based on the at least one data element comprises:
retrieving additional data identifying the contact from the record of the technical problem in the additional data structures; and
retrieving the record of the contact based on the additional data.

10. The computing system of claim 7, further comprising:
at a first time, storing (i) the interaction entry and (ii) the mapping between the identifier and the interaction entry for later retrieval and analysis;
at a second time later than the first time, analyzing (i) stored interaction entries and (ii) stored mappings between identifiers and corresponding interaction entries to identify one or more patterns in the technical problems requested to be addressed on behalf of the one or more of the contacts;
generating a profile of the technical problems based on the one or more patterns, wherein the profile indicates frequencies with which different types of the technical problems are requested to be addressed on behalf of the one or more of the contacts; and
storing the profile to be used in modifying a managed network in which at least a portion of the technical problems occur.

11. The computing system of claim 6, wherein receiving the plurality of data identifying the contact comprises:
receiving the plurality of data by way of an interactive voice response system, wherein the communication with the contact comprises a voice communication.

12. The computing system of claim 6, wherein receiving the plurality of data identifying the contact comprises:
receiving the plurality of data by way of a chat system, wherein the communication with the contact comprises a chat communication.

13. The computing system of claim 6, wherein receiving the plurality of data identifying the contact comprises:
receiving the plurality of data from a computing device configured to store the plurality of data in association with log-in credentials of the contact, wherein the computing device is configured to provide the plurality of data in response to the contact requesting to start the interaction by way of the computing device after providing the log-in credentials to the computing device.

14. The computing system of claim 6, wherein receiving the plurality of data identifying the contact comprises:
receiving the plurality of data from the contact by way of a web-based form.

15. The computing system of claim 6, wherein providing the indication on the interaction entry that the identity of the contact has been authenticated comprises:
displaying visual indicia indicating a status of an authentication of the identity of the contact, wherein the visual indicia has a first appearance when the identity of the contact has been verified and a second different appearance when the identity of the contact has not been verified.

16. A computer-implemented method comprising:
receiving, by an interaction management application executing on a server device and from a contact, a plurality of data identifying the contact, wherein the plurality of data is received before starting an interaction related to a technical problem, and wherein the interaction comprises a communication with the contact;
generating, by the interaction management application, an interaction entry representing the interaction, wherein the interaction entry comprises input fields to identify the contact and the technical problem;
retrieving, by the interaction management application and from data structures in persistent storage storing a plurality of records of contacts, a record of the contact based on at least one data element of the plurality of data, wherein each record of the plurality of records comprises information identifying a corresponding contact;
authenticating an identity of the contact based on the plurality of data matching the record of the contact; and
based on authenticating the identity of the contact, (i) populating, by the interaction management application, one or more of the input fields of the interaction entry with corresponding information from the record of the contact, (ii) providing, by the interaction management application, an indication on the interaction entry that the identity of the contact has been authenticated, and (iii) starting, by the interaction management application, the interaction.

17. The computer-implemented method of claim 16, further comprising:
receiving, from the contact, an identifier associated with a record of the technical problem stored in additional data structures contained in the persistent storage, wherein the additional data structures store a plurality of records of technical problems requested to be addressed on behalf of one or more of the contacts;
retrieving the record of the technical problem from the additional data structures using the identifier;
generating a mapping between the identifier and the interaction entry to indicate the technical problem addressed during the interaction; and
storing the generated mapping in the interaction entry.

18. The computer-implemented method of claim 17, wherein the identifier associated with the record of the technical problem is received before starting the interaction related to the technical problem.

19. The computer-implemented method of claim 17, wherein the plurality of data identifying the contact comprises at least the identifier associated with the record of the technical problem, and wherein retrieving the record of the contact based on the at least one data element comprises:
retrieving additional data identifying the contact from the record of the technical problem in the additional data structures; and
retrieving the record of the contact based on the additional data.

20. The computer-implemented method of claim 17, further comprising:
at a first time, storing (i) the interaction entry and (ii) the mapping between the identifier and the interaction entry for later retrieval and analysis;
at a second time later than the first time, analyzing (i) stored interaction entries and (ii) stored mappings between identifiers and corresponding interaction entries to identify one or more patterns in the technical problems requested to be addressed on behalf of the one or more of the contacts;
generating a profile of the technical problems based on the one or more patterns, wherein the profile indicates frequencies with which different types of the technical problems are requested to be addressed on behalf of the one or more of the contacts; and
storing the profile to be used in modifying a managed network in which at least a portion of the technical problems occur.
